(19) United States
(12) Patent Application Publication
(10) Pub. No.: US 2008/0210781 A1
(43) Pub. Date: Sep. 4, 2008

(54) POWER-OPERATED SPRAYER, FOR MANUAL USE

(75) Inventor: Saturnino Insausti Eciolaza, Idiazabal (Gipuzkoa) (ES)

Correspondence Address: DARBY & DARBY P.C., P.O. BOX 770, Church Street Station, New York, NY, 10008-0770, US

(73) Assignee: GOIZPER, S. COOP., Antzuola (Guipuzkoa) (ES)

(21) Appl. No.: 12/019,101

(22) Filed: Jan. 24, 2008

(30) Foreign Application Priority Data
Jan. 29, 2007 (ES) 200700225

(51) Int. Cl. B05B 9/04

(52) U.S. Cl. 239/373

(57) ABSTRACT

The sprayer comprises a tank carrying the liquid to be sprayed and a motor-compressor assembly intended to supply air under pressure to the tank for the liquid, which comprises a self-contained assembly that can be coupled to the tank for the liquid and an elongate body which is introduced into the tank for the liquid and which carries an assembly of dry or rechargeable batteries, said self-contained assembly also having an upper body carrying the handle for holding the sprayer, the electric motor with its reduction gear train and the compressor, which communicates directly via an internal pipe with the inside of the tank carrying the liquid. It is intended for agriculture, gardening and other applications.

The present invention is intended to disclose a power-operated sprayer, for manual use, which contributes significant characteristics of novelty and inventive step to the prior art.

The new sprayer arrangement of the invention permits easy introduction of air under pressure in the tank, which hitherto constituted a certain complication in the known apparatuses.

Sprayers for manual use are intended for multiple functions of a domestic and semi-industrial type in gardening, agriculture and other applications in which there is a need to spray a product of varying type for the purpose of plant health treatment or other types of treatment, numerous types of said apparatuses being known. As a rule, the technical difficulty which arises in sprayers of this type lies in obtaining a regular air pressure so that the spraying of the product is homogeneous. To this end, various systems are utilised, including those which provide air compressed by external means through the corresponding piping, with an assembly of elements which is fairly cumbersome, or self-contained power-operated apparatuses of different types which also have the drawback of excessive weight, unbalanced mass with respect to the hand during use, rendering the spraying operation difficult, etc.

The function of pressure regulation is of special interest since in many applications of an agricultural or sanitary type, especially in the case of government contracts or international organisations, regulation of the application pressure is demanded, which the sprayer of the present invention will provide automatically owing to its constitution.

For this reason, the inventors carried out numerous tests and trials in order to obtain a light and manageable power-operated spraying apparatus for manual application which permits its application both for the spraying of plant health products, as well as paints and varnishes or other products, widening its field of application in the domestic and do-it-yourself sector.

In order to achieve its aims, the present invention discloses a power-operated sprayer for manual application which is characterized by the combination of a container of dry batteries or rechargeable batteries for supplying power to the electric motor driving the compressor, which is arranged centrally inside the tank, and a motor and compressor assembly on the outside of the tank, in a body which incorporates the handle of the apparatus, thereby making it possible to obtain significant ergonomic characteristics by concentrating the mass of the sprayer centrally with respect to the tank and as close as possible to the user's hand.

The compressor will be of the single or double piston type, fed by a voltage of between 4 and 8 volts, with an especially low consumption, permitting an extended life of the dry batteries or a much longer-lasting charge of the rechargeable batteries, one or other being arranged in a tubular member which is integral with the handle and motor-compressor assembly.

The assembly consisting of the sealed container assembly for the batteries which is mounted inside the tank with the liquid to be sprayed and the upper body carrying the mechanical members of the motor-compressor and the handle will form a self-contained assembly which can be separated from the sprayer, being able to be marketed independently for its optional incorporation into the tank, which has a screw thread having the same characteristics, or permitting its easy incorporation into different tanks intended for different products.

For greater comprehension thereof, drawings of a preferred embodiment of the present invention are appended by way of non-limiting example.

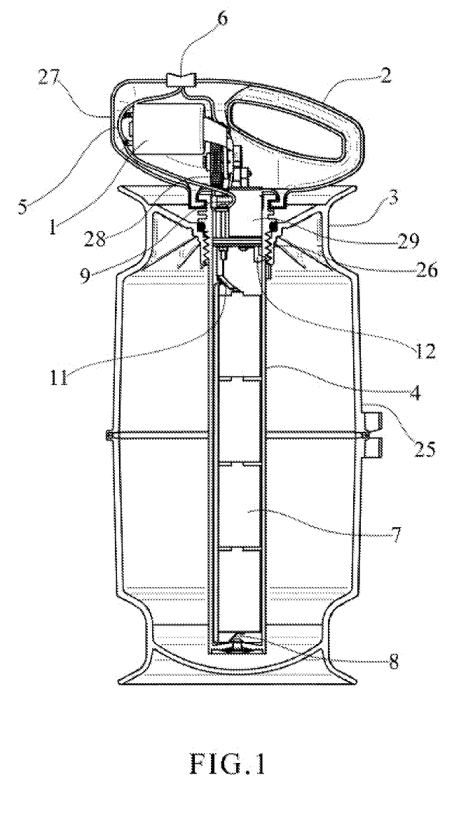

FIG. 1 shows a complete section of a power-operated compressor for manual operation according to the present invention.

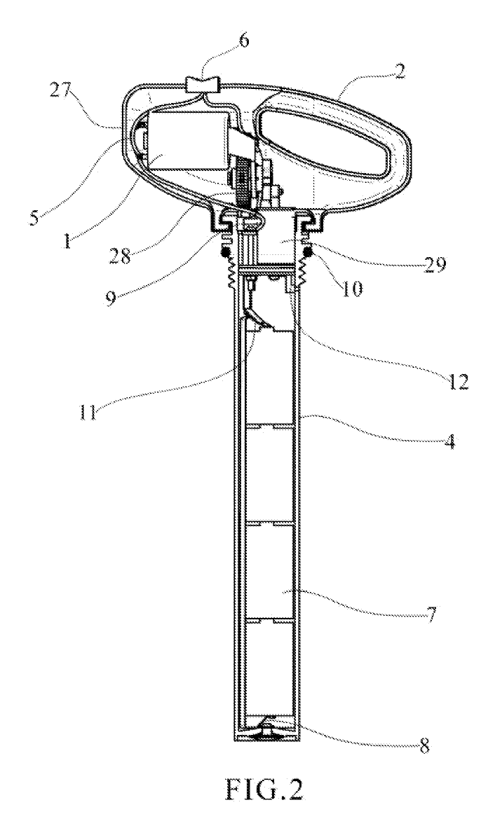

FIG. 2 shows a view from the front and in section of the assembly carrying the rechargeable or non rechargeable batteries for operation and the body, carrying the mechanisms, with handle.

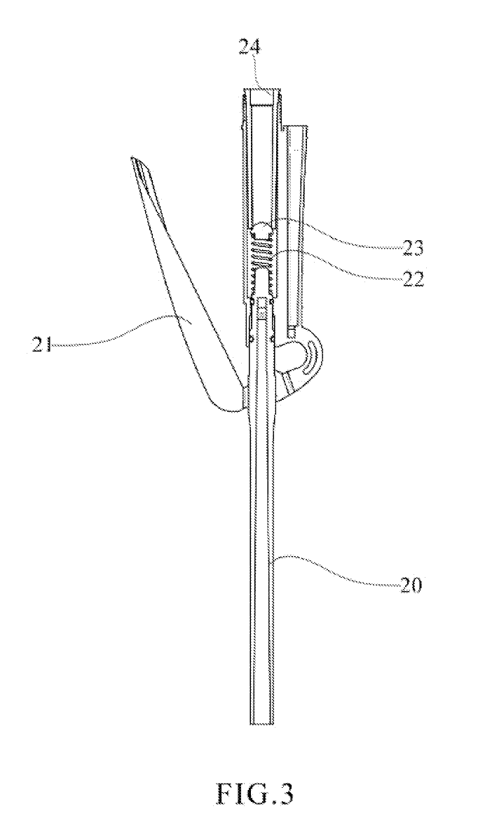

FIG. 3 shows a view of the control device for controlling the spraying nozzle.

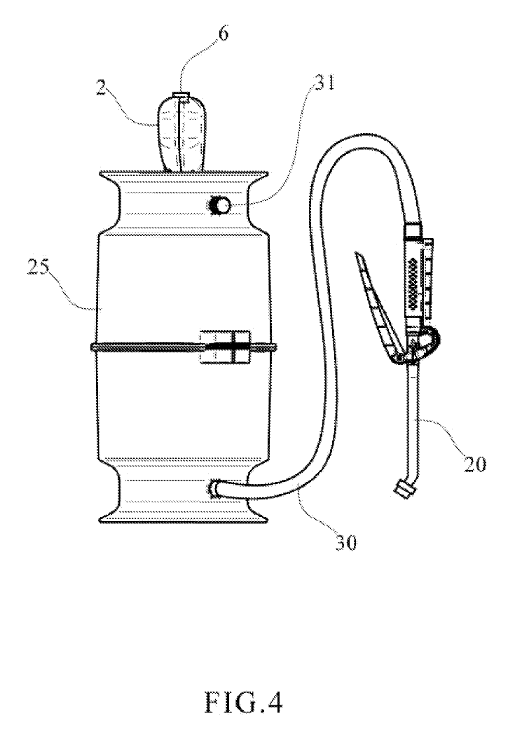

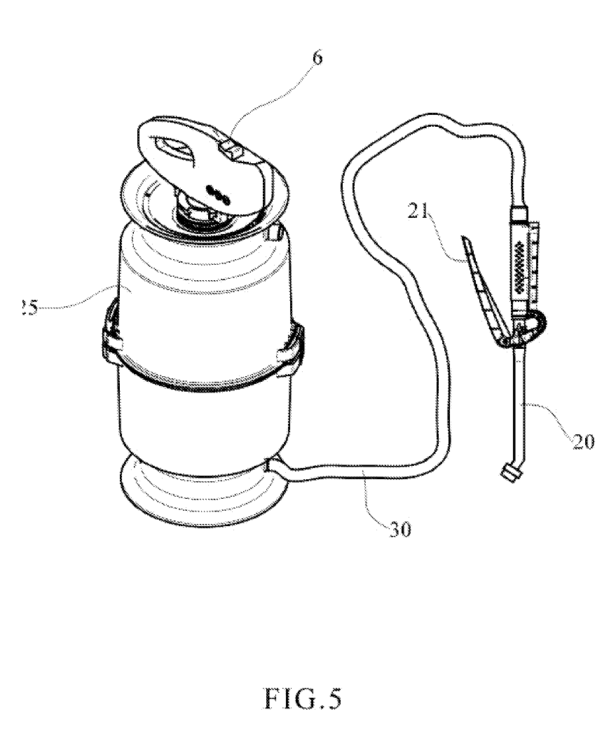

FIGS. 4 and 5 show, respectively, a view from the front and a perspective view of the sprayer of the present invention.

As can be seen in the drawings, the sprayer of the present invention comprises a tank 25 intended for the liquid to be sprayed, and which has a wide upper neck 3 with a screw-threaded zone 26 on which is coupled, with sealing means constituted, for example, by a sealing O-ring 10, a removable assembly which has been shown individually in FIG. 2 and is formed by the body of tubular structure 4 carrying the batteries arranged along the longitudinal axis of the tank 25, and which contains within it the dry or rechargeable batteries 7, which tank incorporates at the top a body 27 in which is incorporated the motor and compressor assembly, of which can be seen the motor 1, reduction gear train 28 and compressor 29, which may preferably be of the single or double piston type, being of the type known as low consumption type. In the actual body 27 are incorporated the handle 2 and the actuating switch 6 for the motor-compressor. The cables 5, which have been shown diagrammatically, connect the switch 6 to the power source, constituted by the dry or rechargeable batteries 7, via contact lugs 8 and 11 and also to the motor 1.

The compressor 29 is mounted on the upper part of the tubular body 4 carrying the batteries and may be of the piston type, as indicated, or of another type.

The compressed air is transmitted directly from the compressor 29 to the inside of the tank 25 via a simple internal pipe 12.

A control assembly 9 has as its function especially the regulation of the output pressure of the compressed air to the desired values.

The power source will preferably be based on dry batteries, as shown in the drawings, owing to their simplicity and ease of economic replacement, although rechargeable batteries of known type may also be incorporated.

The sprayer of the present invention is completed by means of the flexible tubing 30 for connection to the manual control assembly for controlling spraying, which comprises the handle 21 with flexible type coupling, the tube with closure 20 which will incorporate the spraying nozzle, not shown in the drawings, the inner spring 22, stop 23 and closure stop 24.

Although it has not been explained in detail owing to its conventional nature, the sprayer will also include a safety valve 31 in order to prevent over-pressures inside the tank 25.

Although the sprayer of the present invention has been described and explained in detail on the basis of an exemplary embodiment, it will be understood that numerous modifications may be introduced therein without departing from the scope of the present invention, which is defined by the following claims.

1. A power-operated sprayer for manual use, comprising a tank carrying a liquid to be sprayed and a motor-compressor assembly intended to supply air under pressure to the tank for the liquid, further comprising a self-contained assembly that can be coupled to the tank for the liquid and which comprises a tubular body which is introduced into the tank for the liquid and which carries an assembly of dry or rechargeable batteries; said self-contained assembly also having an upper body carrying the handle for holding the sprayer, the electric motor with its reduction gear train and the motor-compressor, which communicates directly by means of an internal pipe with the inside of the tank carrying the liquid.

2. The power-operated sprayer for manual use of claim 1, wherein the axis of the tubular body carrying the dry or rechargeable batteries, once coupled, coincides with the longitudinal axis of the tank for the liquid.

3. The power-operated sprayer for manual use of claim 1, wherein the compressor is of the single or double piston type.

4. The power-operated sprayer for manual use of claim 1, wherein the compressor is incorporated in the upper part of the tubular body carrying the dry or rechargeable batteries.

5. The power-operated sprayer for manual use of claim 1, characterized by the incorporation of a control assembly for regulating the air pressure inside the tank, incorporated in the assembly of members of the body carrying the motor-compressor assembly.
